(19) United States
(12) Patent Application Publication
(10) Pub. No.: US 2007/0231646 A1
(43) Pub. Date: Oct. 4, 2007

(54) Fuel flow board for the fuel cell

(76) Inventors: Hsi-Ming Shu, Taipei (TW); Wei-Li Huang, Taoyuan (TW)

Correspondence Address: G.LINK CO., LTD, 3550 Bell Road, MINOOKA, IL, 00447, US

(21) Appl. No.: 11/390,090

(22) Filed: Mar. 28, 2006

(51) Int. Cl. H01M 8/04; H01M 8/02

(52) U.S. Cl. 429/26; 429/38

(57) ABSTRACT

A fuel flow board for a fuel cell includes a body, at least fuel supply portion and at least a dissipating component. The fuel supply portions are disposed on the surface of the body. The dissipating component is disposed within the body. A part of the dissipating component protrudes from the body. The dissipating component is averagely deployed on the whole area of the fuel supply portion.

### FIELD OF THE INVENTION

The present invention relates to a dissipating structure of a fuel flow board in a fuel cell, and more particularly, to a fuel flow board for a fuel cell, which integrates the functions of flowing and dissipating.

### BACKGROUND OF THE INVENTION

Prior arts about fuel flow boards of fuel cells usually emphasize modifying the flowing structures thereof, in order to flow fuel from the fuel flow boards into the membrane electrode assemblies (MEAs) smoothly. Unfortunately, heat is produced by MEAs during electrochemical reactions, and the existent heat has poor influence on the efficiency of generating power by the MEAs. Accordingly, some solutions have been employed in fuel cells. A conventional heat sink used in the fuel cell and a fuel flow board, however, are independent structures, instead of an integral structure as a whole. It is apparent that utilizing the conventional combination of a fuel flow board and a heat sink cannot reduce the volume of a fuel cell. Consequently, it is quiet difficult to apply fuel cells to current portable electronic products.

Therefore, an improved fuel flow board for a fuel cell is provided to overcome the aforesaid disadvantages. The fuel flow board of the invention possesses both functions of flowing and dissipating.

### SUMMARY OF THE INVENTION

It is a primary object of the invention to provide a fuel flow board for a fuel cell, which furnishes fuel with a flow structure and dissipates heat within an operated fuel cell as well.

In accordance with the aforesaid object of the invention, a fuel flow board for a fuel cell is provided. The fuel flow board comprises a body, at least one fuel supply portion and a dissipating component. The fuel supply portions are disposed on the surface of the body. The dissipating component is disposed within the body. A part of the dissipating component protrudes from the body. The dissipating component is deployed on the entire area of the fuel supply portions averagely.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 is an exploded diagram showing the structure of a fuel cell having a fuel flow board in accordance with one embodiment of the invention;

FIG. 2 illustrates the top view of a fuel flow board for a fuel cell according to one embodiment of the invention;

FIG. 3 illustrates the cross section view of FIG. 2 along the line I-I;

FIG. 4 illustrates the cross section view of FIG. 2 along the line II-II;

FIG. 5 illustrates the cross section view of a fuel flow board according to another embodiment of the invention; and

FIGS. 6A through 6C respectively illustrate the top views of fuel flow boards for a fuel cell according to the other embodiments of the invention.

### DETAILED DESCRIPTION OF THE INVENTION

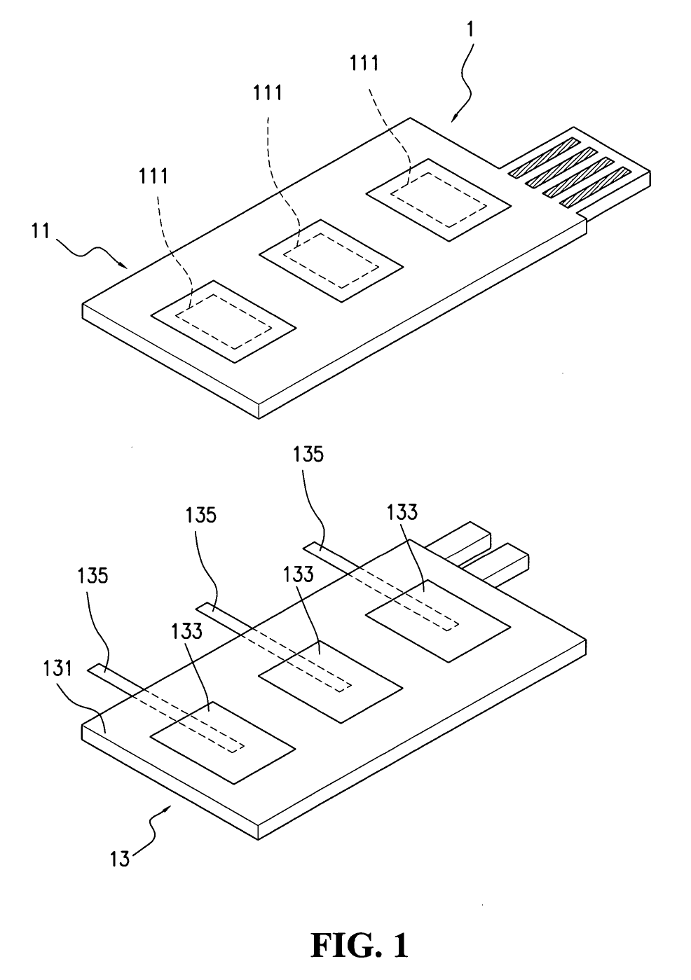

FIG. 1 is an exploded diagram showing the structure of a fuel cell having a fuel flow board in accordance with one embodiment of the invention. A fuel cell 1 includes a fuel cell board 11 and a fuel flow board 13. The fuel cell board 11 comprises at least a membrane electrode assembly (MEA) 111. Each MEA 111 is individually disposed corresponding to a fuel supply portion 133 of the fuel flow board 13. While the fuel cell 1 is assembled, the fuel cell board 11 and the fuel flow board 13 are sealed and connected with each other. The fuel cell board 11 may be a direct methanol fuel cell (DMFC) board. After flowing into the fuel flow board 13, fuel like methanol inside the fuel supply portions 133 flows into the MEAs 111. As a result, the MEAs 111 perform electrochemical reactions and generate power. The MEAs 111 also produce heat when operated. Such remaining heat therein deteriorates the efficiency of generating power by the MEAs. It is noted that the fuel flow board 13 possesses the function of dissipating, so as to be able to dissipate heat within the fuel cell 1.

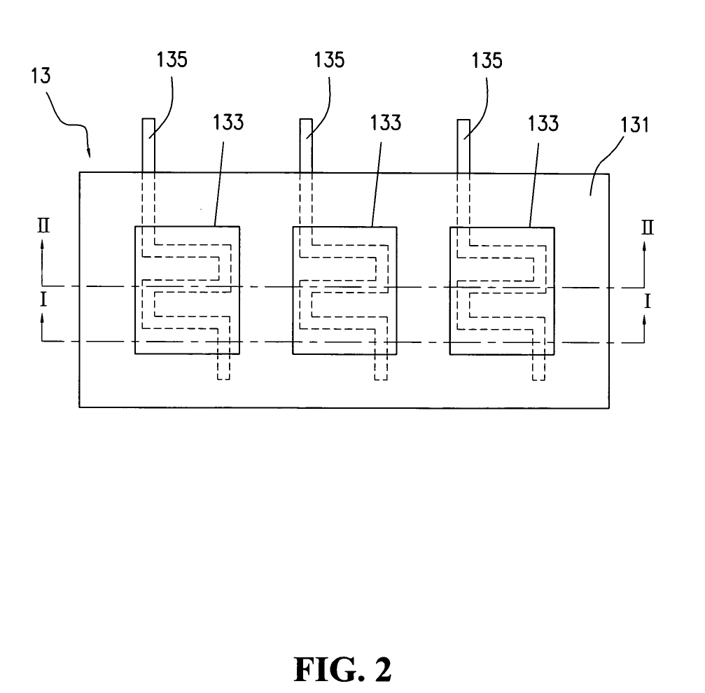

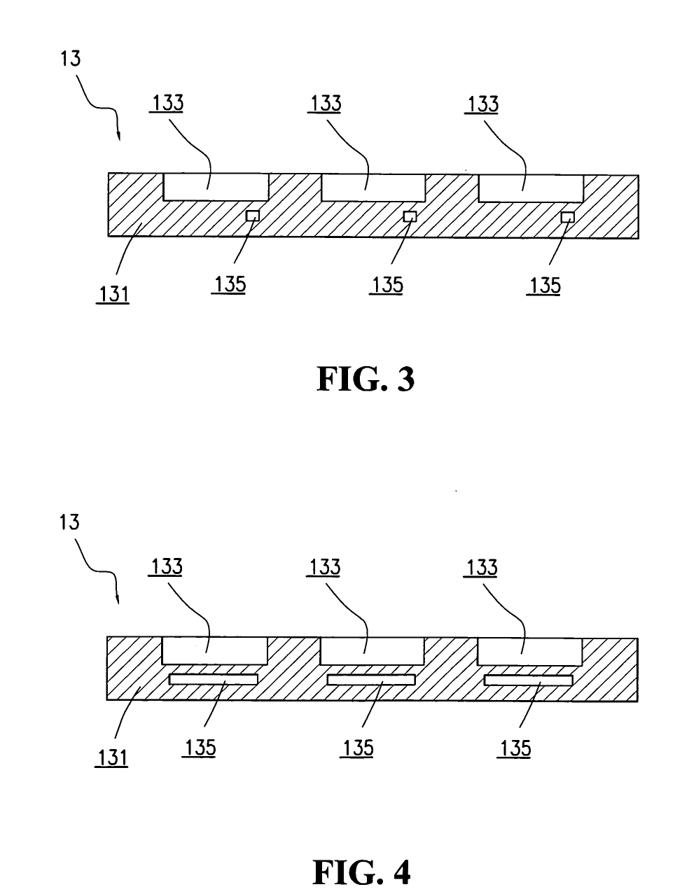

FIG. 2 illustrates the top view of a fuel flow board for a fuel cell according to one embodiment of the invention. FIG. 3 illustrates the cross section view of FIG. 2 along the line I-I. FIG. 4 illustrates the cross section view of FIG. 2 along the line II-II. Referring to these Figs., the fuel flow board 13 includes a body 131, fuel supply portions 133 and dissipating components 135. The fuel supply portions 133 are disposed on the surface of the body 131, and their quantity depends on the numbers of the MEAs 111. The dissipating components 135 are sandwiched in between the stacked layers of the body 131, and a part of each of the dissipating component 135 protrudes from the body 131. Moreover, the dissipating components 135 are deployed on the total area of the fuel supply portions 133 averagely.

As shown in FIG. 2, FIG. 3 and FIG. 4, each fuel supply portion 133 of the fuel flow board 13 is individually disposed corresponding to a dissipating component 135 sandwiched within the body 131. Furthermore, an end of the dissipating component 135 protrudes from the body 131. Heat produced by the MEAs 111 during electrochemical reactions is thus conducted to the dissipating components 135, and then is taken away from the protruding end of the dissipating components 135. The operational temperature inside the fuel cell 1 is lowered accordingly.

An exemplar of the dissipating components 135 may include any structure that can conduct heat. For example, the thermal conductive structure may take advantage of its own material to directly conduct heat away. The thermal conductive structure may be made of metal that has good thermal conductivity, and may be in the form of a solid pillar, a hollow pillar, or a plate. The structure may be disposed within the body 131, and may be zigzagged or linearly extended to be various geometric patterns for covering the entire area of the fuel supply portions 133 averagely. A protruding end of the dissipating component 135 may be further connected to a heat sink or a cooling system, in order to dissipate heat more completely. Or, a protruding end of the dissipating component 135 may be exposed in the external air, so as to remove heat outside.

The dissipating component 135 has, for instance, a structure of a hollow tube. A fluid may flow through the hollow tube, by which heat is removed out of the fuel cell 1. The structure of hollow tube may be a heat pipe. Hence, heat generated by the MEAs 111 is removed by means of the heat pipe.

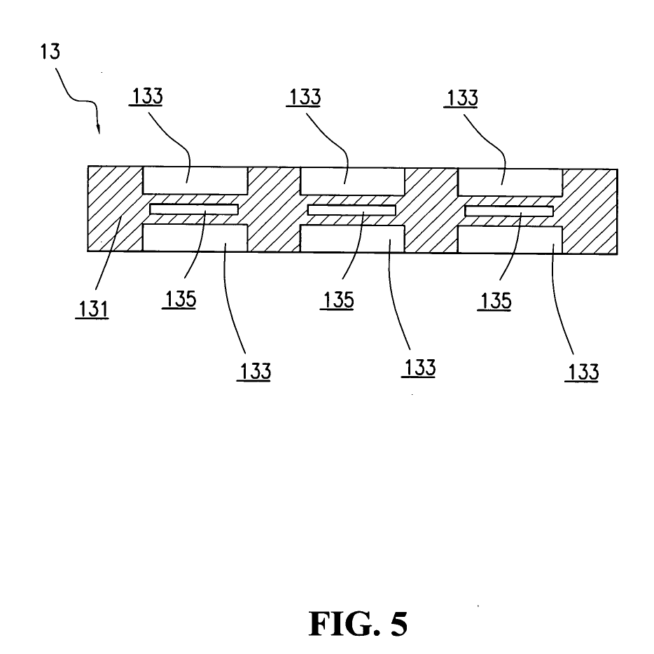

FIG. 5 illustrates the cross section view of a fuel flow board according to another embodiment of the invention. The fuel supply portions 133 are disposed on the upper and lower surfaces of the fuel flow board 13, respectively. The dissipating component 135 sandwiched within the body 131 dissipates heat produced by the MEAs 111 disposed on the top and bottom (not shown).

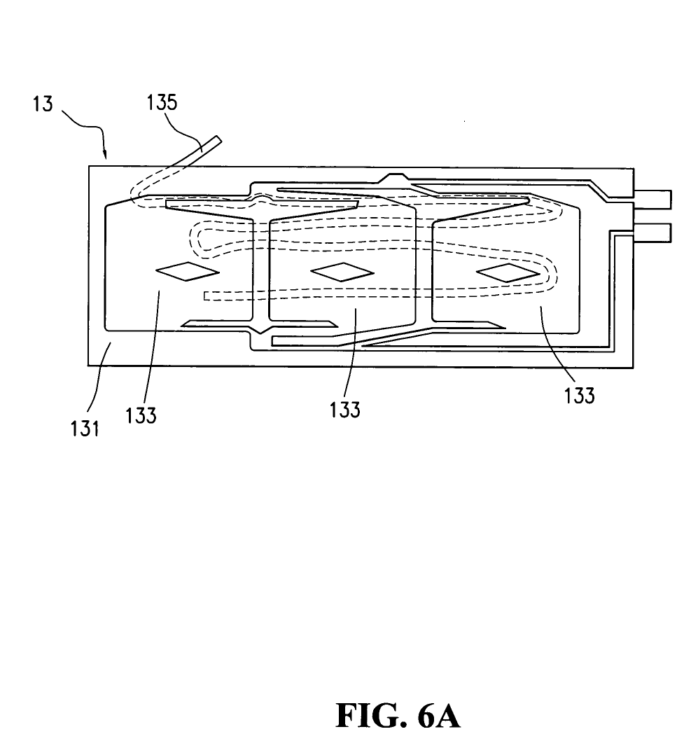

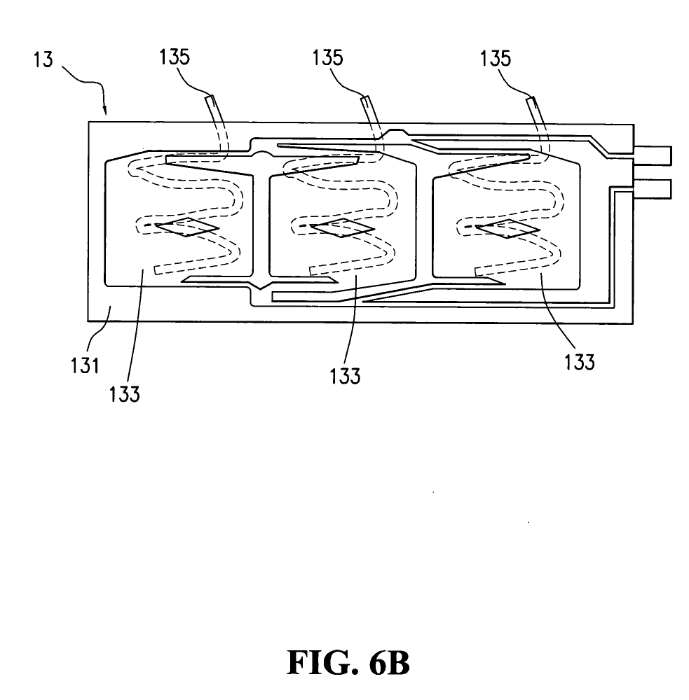

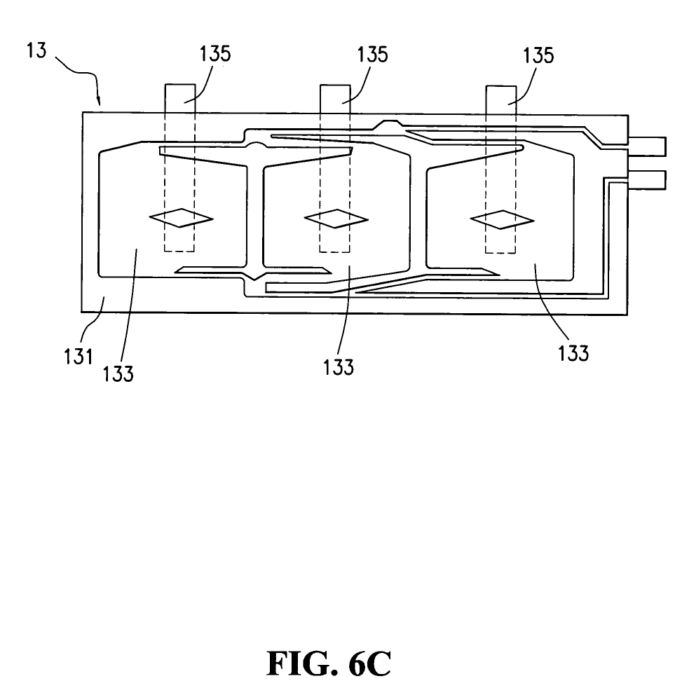

FIGS. 6A through 6C separately illustrate the top views of fuel flow boards for a fuel cell according to other embodiments of the invention. The dissipating component 135 in FIG. 6A is a heat sink with an integral structure. In FIG. 6B and FIG. 6C, the dissipating components 135 are independent heat sinks spaced apart from one another. FIG. 6B shows that the dissipating component 135 is deployed in a zigzag manner. FIG. 6C shows that the dissipating component 135 has a linear pattern.

The body 131 may utilize a substrate made of good adhesive material, such as a plastic substrate, a ceramic substrate, a printed circuit substrate, or a polymer plastic substrate.

The aforementioned fuel flow board combines the structures for flowing and dissipating, of which performance is superior to a traditional fuel flow board. It is also feasible to manufacture a miniaturized fuel cell using such fuel flow board.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and detail may be made therein without departing from the spirit and scope of the invention, as set forth in the following claims.

What is claimed is:

1. A fuel flow board for a fuel cell, the fuel flow board comprising:
a body;
at least a fuel supply portion disposed on a surface of the body; and
at least a dissipating component disposed within the body, wherein a part of the dissipating component protrudes from the body, and the dissipating components are deployed on the total area of the fuel supply portions averagely.

2. The fuel flow board of claim 1, wherein a material of the dissipating component has good thermal conductivity.

3. The fuel flow board of claim 1, wherein a material of the dissipating component is metal.

4. The fuel flow board of claim 1, wherein the dissipating components are an integral heat sink zigzagged and averagely deployed on the total area of the fuel supply portion.

5. The fuel flow board of claim 1, wherein the dissipating components comprise one or more isolated heat sinks and each of the heat sinks is averagely deployed on an entire area of a corresponding fuel supply portion.

6. The fuel flow board of claim 4, wherein the dissipating components are an integral hollow tube for containing a fluid passing through.

7. The fuel flow board of claim 5, wherein the isolated heat sink is a hollow tube for containing a fluid passing through.

8. The fuel flow board of claim 1, wherein the dissipating components are heat pipes.

9. The fuel flow board of claim 4, wherein the dissipating components are an integral heat pipe.

10. The fuel flow board of claim 5, wherein the isolated heat sink is a heat pipe.

11. The fuel flow board of claim 1, wherein the fuel flow board is a single-sided fuel flow board.

12. The fuel flow board of claim 1, wherein the fuel flow board is a two-sided fuel flow board.

13. The fuel flow board of claim 1, wherein the body is a plastic substrate, a ceramic substrate, a printed circuit substrate, or a polymer plastic substrate.
